(19) United States
(12) Patent Application Publication
(10) Pub. No.: US 2014/0078061 A1
(43) Pub. Date: Mar. 20, 2014

(54) COGNITIVE BIOMETRICS USING MOUSE PERTURBATION

(71) Applicant: Teledyne Scientific & Imaging, LLC, Thousand Oaks, CA (US)

(72) Inventors: Stephen Simons, Raleigh, NC (US); Jiangying Zhou, Durham, NC (US); Yuwei Liao, Cary, NC (US); Laura Bradway, Copenhagen S. (DK); Mario Aguilar, Jacksonville, AL (US); Patrick M. Connolly, Cary, NC (US)

(21) Appl. No.: 14/011,351

(22) Filed: Aug. 27, 2013

Related U.S. Application Data
(60) Provisional application No. 61/703,694, filed on Sep. 20, 2012.

(51) Int. Cl. G06F 3/0354

(52) U.S. Cl. CPC G06F 3/03543
USPC 345/163

(57) ABSTRACT

Cognitive biometrics comprises augmenting the richness of biometric signatures that can be extracted from mouse dynamics by introducing perturbations in the response of the computer mouse and measuring the motor responses of the individual user. User responses to unexpected and subtle perturbations (e.g., small changes in mouse velocity, position and/or acceleration) reveal new unique sources of information in the mouse movement signal that reflect the user's cognitive strategies and are inaccessible via existing mouse biometric technologies. A user's response to these perturbations contains information about intrinsic cognitive qualities that can be used as a robust biometric for personal authentication and to support profiling of the individual (e.g., gender, cultural background, cognitive or emotional state, cognitive quality etc.).

### CROSS-REFERENCE TO RELATED APPLICATIONS

This application claims benefit of priority under 35 U.S.C. 119(e) to U.S. Provisional Application No. 61/703,694 entitled “Cognitive Biometrics Using Mouse Perturbation” and filed on Sep. 20, 2012, the entire contents of which are incorporated by reference.

### BACKGROUND OF THE INVENTION

1. Field of the Invention

This invention relates to cyber-security and cognitive biometrics of computers users, and more specifically to techniques for determining and applying cognitive biometrics for user authentication and profiling by monitoring user responses to mouse perturbations.

2. Description of the Related Art

While many efforts in cyber-security seek to prevent, neutralize or minimize the impact of attacks, few efforts are underway to exploit the human element and our understanding of cognition to profile, track and identify insider threats. Cyber threats are posed by both insiders (e.g., employees) and outsiders (e.g., hackers). These hackers may be known or unknown.

One such aspect of cyber-security is to identify computer users through biometric mouse signatures. A current user can be identified and authenticated by comparing real-time mouse signatures to a stored signature. The authentication may be for a known person such as an employee or a previously identified “John Doe” hacker or an unknown person such as a new hacker. In addition to verifying whether the current user of a computer is known and approved, the ability to identify the current user can be used to profile that user based on ongoing mouse events.

State of the art mouse biometric approaches use primary features (e.g., distance, velocity profiles, orientation based metrics) of mouse movement collected during normal mouse use to authenticate individuals (See US 2004/0221171 and U.S. Pat. No. 8,230,232). Normal mouse movement is a highly practiced, ballistic motion. As such, its primary characteristics are relatively similar across individual users. Since these features are taken from the well-practiced ballistic movement of mouse use, they lack individual specificity. As a result, current approaches require large amounts of data and the use of statistical classifiers to discriminate individuals. These constraints make their approaches far less appealing from the standpoint of authentication and profiling, which in many instances requires authentication on a small amount of data.

### SUMMARY OF THE INVENTION

The present invention comprises augmenting the richness of biometric signatures that can be extracted from mouse dynamics by introducing perturbations in the response of the mouse and measuring the motor responses of the individual user. User responses to unexpected and subtle perturbations (e.g., small changes in mouse velocity, position and/or acceleration) reveal new unique sources of information in the mouse movement signal that reflect the user's cognitive strategies and are inaccessible via existing mouse biometric technologies. A user's response to these perturbations contains information about intrinsic cognitive qualities that can be used as a robust biometric for personal authentication and to support profiling of the individual based on a common trait (e.g., gender, age, ethnicity, cultural background, cognitive or emotional state such as situational anxiety, stress or deception, cognitive quality such as trait anxiety, reaction time or problem solving strategies etc.).

In an embodiment, a computer-implemented system for determining biometric signatures based on user mouse events comprises a mouse monitor software module that monitors mouse events (e.g. mouse position, scrolling and clicking events) output by a mouse application program interface (API) coupled to a computer mouse and a mouse perturbation engine software module that tracks the mouse events. The mouse perturbation engine is responsive to certain states (e.g., mouse position, velocity, acceleration) of mouse events to generate a perturbation of a mouse event (e.g. alter the position of the mouse icon, alter the visibility of the mouse icon or change the sensitivity of the mouse to user actions). The mouse perturbation engine communicates the desired perturbation to the API, which then injects the perturbation into the mouse event. The user's response to the unexpected perturbation of mouse control is then measured and catalogued (paired) with the associated perturbation. These pairs may be logged in a mouse database to build biometric signatures for individual users, for classes of users by gender, ethnicity, race, age etc. for known cognitive states (e.g. stress, situational anxiety, deception etc.) or for known cognitive qualities (e.g. trait anxiety, reaction time, etc.) based on the common trait. These pairs may also be provided to an authentication and profiling task module that compares the data to the biometric signatures in the database to authenticate or profile the user. These pairs may be subjected to pre-processing and/or feature extraction before they are logged into the database or forwarded to the task module.

In one embodiment, the biometric signatures for known users are recorded and stored in the database. During a user session on the computer, user mouse events responsive to perturbations are observed and compared to the pre-stored biometric signatures to authenticate the user or to flag an unknown user. An observed and unrecognized biometric signature (e.g., for an unknown user) may be added to the database as John Doe #N for example. The biometric signatures for authenticated users can be updated and refined based on continued monitoring.

In another embodiment, features of biometric signatures across a pool of users may be correlated to a common trait e.g. gender, ethnicity, race, age etc. These features can then be used to profile (gain information on) new or unrecognized users.

In another embodiment, the biometric signatures from a pool of users exhibiting a certain cognitive state may be combined to form a profile indicative of that cognitive state. For example, the users could be placed under mental or physical stress, placed under conditions in which the users are being deceptive such as monitoring known hackers etc. These biometric signatures may be used to monitor authenticated or unauthenticated users to identify the presence or absence of the cognitive state. For example, is an otherwise authenticated user showing signs of stress or deceptive intent? Is an unauthenticated user trying to hack into the system?

In another embodiment, the use of perturbations of mouse events to build biometric signatures may be combined with other known techniques based on unperturbed mouse movement. For example, both unperturbed and perturbed mouse events can be used to build the biometric signatures. Furthermore, both unperturbed and possibly perturbed mouse events for an authenticated user may be used to profile that user.

In another embodiment, the system authenticates the user and continues to gather information to either strengthen the user's biometric signature, strengthen biometric signatures of the same user class or cognitive state or to profile the user.

In another embodiment in which the signatures have previously been linked to common traits, and/or cognitive states, the mouse perturbation engine can be dynamically queried and adjust its output based on the desired features under investigation of the biometric signature. For, example if a particular feature tied to a perturbation in mouse sensitivity is highly correlated with a common trait such as the age of the user, one can configure the mouse perturbation engine to inject this type of perturbation upon the detection of an unauthorized user in order to obtain information on the user's age first.

These and other features and advantages of the invention will be apparent to those skilled in the art from the following detailed description of preferred embodiments, taken together with the accompanying drawings, in which:

### BRIEF DESCRIPTION OF THE DRAWINGS

FIG. 1 is a diagram of a user's mouse movement with and without perturbation;

FIG. 2 is a block diagram of an embodiment of a system for generating perturbation of mouse behavior and monitoring user responses to determine mouse signatures;

FIG. 3 is a diagram in which the cursor position is altered to perturb mouse behavior; and

FIGS. 4a and 4b are diagrams the information content, dynamic range and separability of mouse signatures for different users with and without perturbations.

### DETAILED DESCRIPTION OF THE INVENTION

The present invention comprises augmenting the richness of biometric signatures that can be extracted from mouse dynamics by introducing perturbations in the response of the computer mouse and measuring the motor responses of the individual user. User responses to unexpected and subtle perturbations (e.g., small changes in mouse velocity, position and/or acceleration) reveal new unique sources of information in the mouse movement signal that reflect the user's cognitive strategies and are inaccessible via existing mouse biometric technologies. A user's response to these perturbations contains information about intrinsic cognitive qualities that can be used as a robust biometric for personal authentication and to support profiling of the individual (e.g., gender, cultural background, cognitive or emotional state, cognitive quality etc.). A captured biometric signature is significantly more difficult to fake due to the need to replicate both the timing and type of perturbation and the event-locked response to that perturbation.

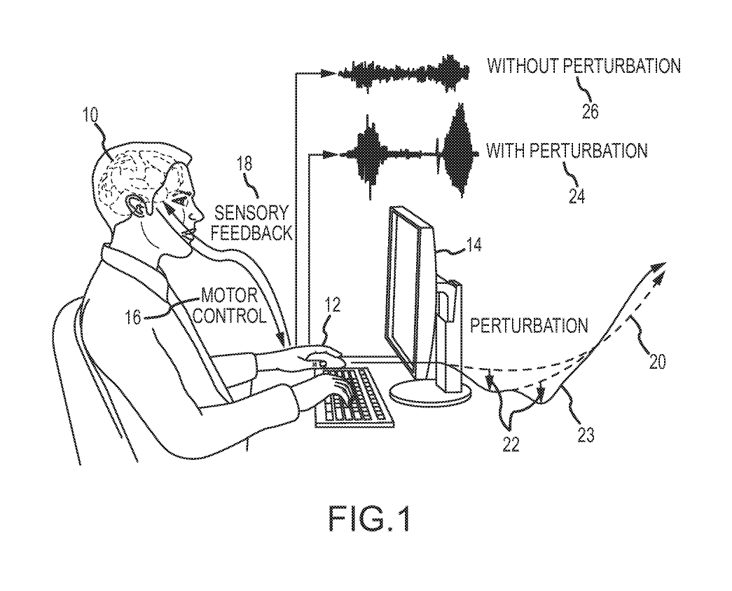

Referring now to FIG. 1, in an embodiment a user 10 is using a computer mouse 12 to interact with a computer system 14 (e.g. a computer processor, computer memory, display, software applications stored in memory and executed by the processor and any data stored in memory). A mouse application program interface (API) implemented on computer system 14 receives various inputs from the mouse due to user actions such as mouse position, scrolling and clicks (“mouse events”). The API generates outputs that control the position of the mouse icon on the display and outputs that interact with other software applications.

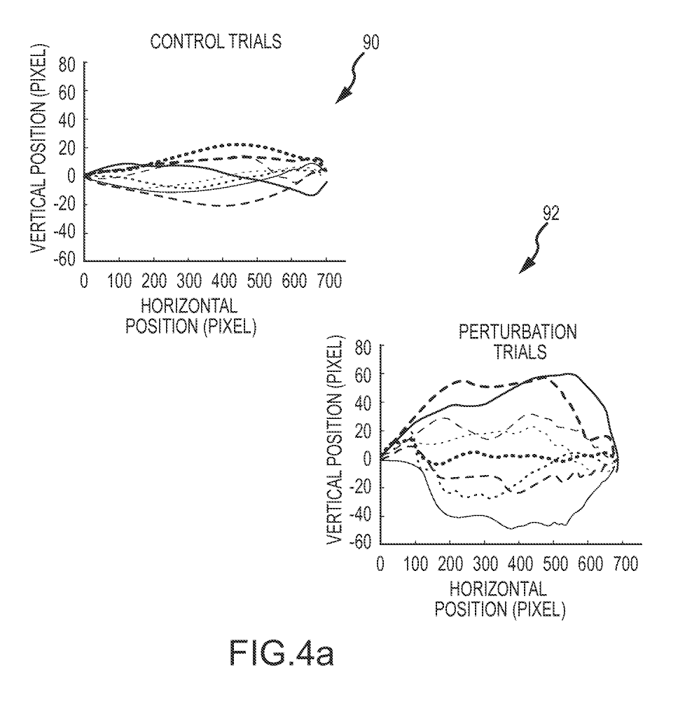

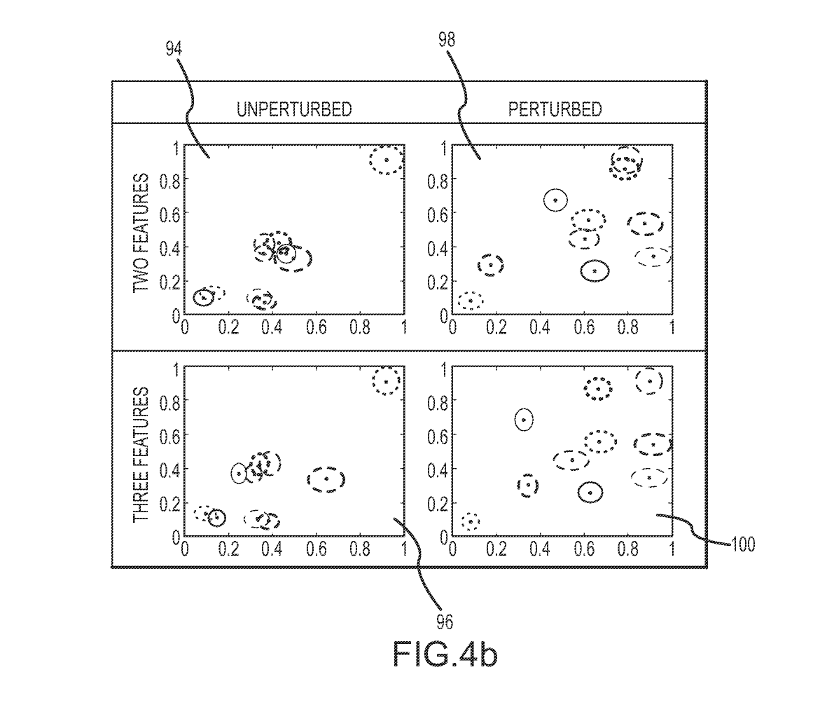

A user's motor control 16 of the mouse in response to sensory feedback 18 e.g. mouse position, mouse visibility, sensitivity of the mouse etc. is indicative of a user's cognitive strategies. As mentioned previously, normal mouse movement (without perturbation) is a highly practiced, ballistic motion 20. As such, its primary characteristics are relatively similar across individual users. The introduction of a perturbation 22 into one or more of the mouse events to produce non-ballistic motion 23, observed through sensory feedback, has been found to evoke differences in motor control in response to the perturbation that has greater variation across individual users. The cognitive response to the perturbations in form of user motor control of the mouse exhibits multiple degrees of freedom, is nonlinear and time-varying, can be locked to the perturbation (stimulus) and is intrinsic to the user (e.g. is a reflection of unique characteristics of an individual rather than usage patterns). The characteristics of a user's motor control 24 with perturbation are more robust than the characteristics 26 without perturbation (see FIG. 4). The perturbed and unperturbed mouse events may be combined to provide a more robust biometric signature, one that can be matched with far less data to authenticate a user. The perturbed responses may also be used to better enable existing profiling techniques or to enable new profiling techniques based on the richness of the perturbed response.

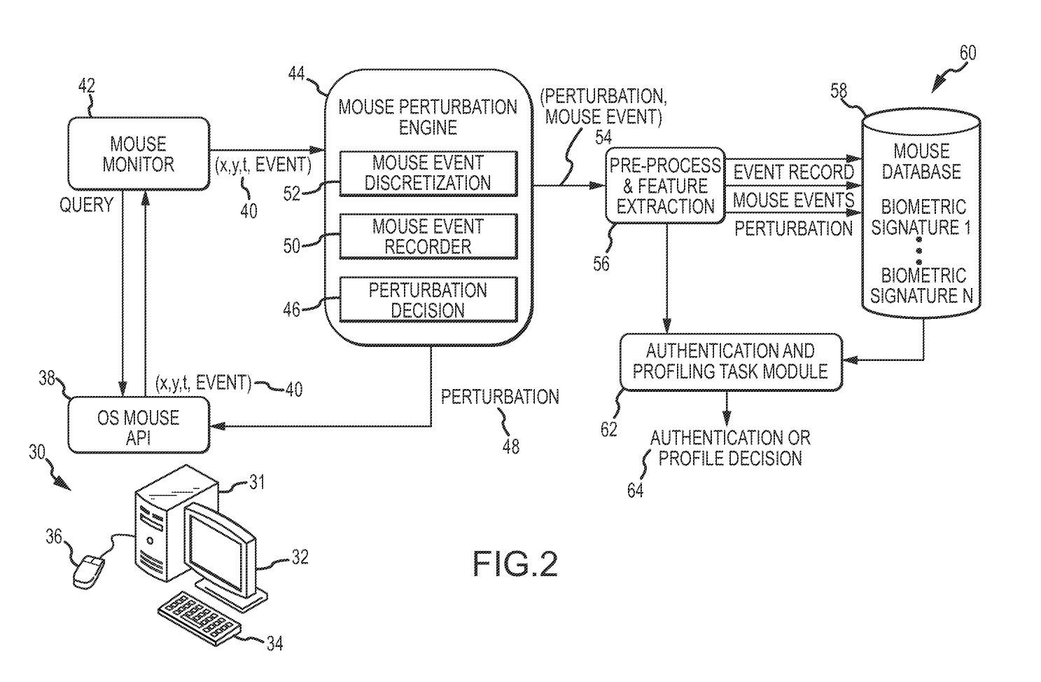

Referring now to FIG. 2, in an embodiment a computer system 30 includes computer processor(s) and computer memory(ies) 31, a display 32, a keyboard 34, a mouse 36, software applications stored in memory and executed by the processor and any data stored in memory. An operating system (OS) mouse API 38 outputs any mouse events 40 e.g. mouse position, scrolling, click etc. as they occur. Each mouse event is tagged with the x,y position, time t and event. A mouse monitor software module 42 stored in memory and executed by the processor monitors the mouse events. Mouse monitor software module 42 may query the Mouse API 38 to read out the mouse events.

A mouse perturbation engine software module 44 stored in memory and executed by the processor tracks the monitored mouse events 40. The engine includes a Perturbation Decision sub-module 46 that is responsive to certain states of mouse events (e.g. a minimum mouse velocity or acceleration, a certain position, a certain angular movement, a certain scrolling event, a certain clicking event or a combination thereof) to generate a perturbation 48 of a mouse event (e.g. altering the position of the mouse icon, altering visibility of the mouse icon by delaying or disabling display of the icon, changing the velocity or acceleration sensitivity of the mouse to user actions, altering the mouse click response including altering a delay or suspending the mouse click, and altering the scrolling). The engine outputs the perturbation 48 to the mouse API 38 to implement the perturbation of the ongoing mouse event. The mouse API requires no modifications. The API time stamps each perturbation as it is implemented. The engine includes a Mouse Event Recorder sub-module 50 that records all mouse events 38 responsive to the perturbation (e.g. all mouse events that fall within a specified window of time after the perturbation or all mouse events between defined start and stop conditions such as maximum and minimum mouse velocity). The engine includes a Mouse Event Discretization module 52 that segments the incoming mouse events 38 into discrete units and assigns an event number e.g. 1, 2, 3 etc. to each time-stamped perturbation and forms pairs 54 of the perturbation with the mouse events responsive to that perturbation.

A pre-processing and feature extraction software module 56, stored in memory and executed by the processor, pre-processes the pairs 54 to, for example, remove corrupt or inappropriate data, perform various signal processing tasks to improve the feature quality of mouse events and/or extract features such as velocity, acceleration, positional deviation, time to target acquisition, over/undershoot dynamics, angular variation etc. for each pair (or combinations of pairs).

The extracted features (e.g., event record, mouse events, perturbations) are logged in a mouse database 58 to build a biometric signature 60 for individual users, for classes of users by gender, ethnicity, race, age etc. or based on cognitive state (e.g. stress, situational anxiety, deception etc.) or cognitive quality (reaction time, trait anxiety etc.) as the common trait. Cognitive states and qualities may be a common trait or may be used alone or in combination to discern other common traits such as gender, ethnicity etc. A cognitive state is transitory in nature whereas a cognitive quality is permanent. Typically, mouse event data in both perturbed and unperturbed conditions will be used to build the biometric signatures 60.

The unperturbed and perturbed mouse events (or features extracted therefrom) are also provided to an authentication and profiling task module 62 stored in memory and executed by the processor that compares the mouse events (or features) to the pre-stored biometric signatures 60 in the database to generate an output 64 to authenticate or profile the user. In general, if and when possible it is advisable to utilize (to the maximum extent possible) the responses to perturbed mouse events due to the fact that inclusion of unperturbed data may quickly invite inaccuracies that plague current approaches.

In different embodiments, the pre-processing and feature extraction module 56, mouse database 58 and authentication and profiling task module 64 may all be implemented in computer system 30 or may be implemented in different local or remote computer systems.

In an embodiment, both perturbed and unperturbed data is used to quickly authenticate the user to continue gathering user mouse events to profile the user. To build accurate and discriminable signatures, a user must typically be monitored over multiple computer sessions for an extended period of time. However, in most situations it is very important to be able to authenticate the user accurately and quickly. The inclusion of perturbed data to both build the biometric signature and then to match the signature provides for much quicker authentication because of the increased information content contained in the perturbed data. In an embodiment, once authenticated conventional techniques using only unperturbed responses are used. In another embodiment, once authenticated conventional techniques using both the unperturbed and perturbed responses are used. In another embodiment, once authenticated new techniques designed to exploit the richness of the perturbed response are used.

In one embodiment, the biometric signatures for known users are recorded and stored in the database. During use of the computer, user mouse events responsive to perturbations are recorded and compared to the biometric signatures to authenticate the user or to flag an unknown user. A biometric profile for the unknown user may be added to the database as John Doe #N for example. The biometric signatures for authenticated users can be updated and refined based on continued monitoring.

In another embodiment, the biometric signatures for authenticated users may be correlated to a common trait of known users e.g. gender, ethnicity, race, age etc. These features may be used to profile (gain information on) new or unrecognized users.

In another embodiment, the biometric signatures from a pool of users exhibiting a certain cognitive state may be combined to form a mouse profile indicative of that cognitive state. For example, the users could be placed under mental or physical stress, placed under conditions in which the users are being deceptive such as monitoring known hackers etc. These biometric signatures may be used to monitor authenticated or unauthenticated users to identify the presence or absence of the cognitive state. For example, is an otherwise authenticated user showing signs of stress or deceptive intent? Is an unauthenticated user trying to hack into the system?

In another embodiment, the use of perturbations of mouse events and the biometric signatures may be combined with other known techniques based on unperturbed mouse movement. For example, both unperturbed and perturbed mouse events can be used to build the biometric signatures. Furthermore, both unperturbed and possibly perturbed mouse events for an authenticated user may be used to profile that user.

In another embodiment, the system authenticates the user and continues to gather information to either strengthen the user's biometric signature, strengthen biometric signatures of the same user class or cognitive state or to profile the user.

In another embodiment in which the signatures have previously been linked to user factors, and cognitive state, the mouse perturbation engine can be dynamically queried and adjust its output based on the desired features under investigation of the biometric signature. For, example if a particular feature tied to a perturbation in mouse sensitivity is highly correlated with a common trait such as the age of the user, one can configure the mouse perturbation engine to inject this type of perturbation upon the detection of an unauthorized user in order to obtain information on the user's age first. The mouse perturbation engine could inject one or more specific perturbations designed to determine a first common trait such as gender. Depending on the determination of the user's gender, the mouse perturbation engine could then inject one or more specific perturbations designed to determine a second common trait and so forth. This approach may determine a well-defined sub-class for the user, a limited number of known candidates that could be the user or identify the specific user.

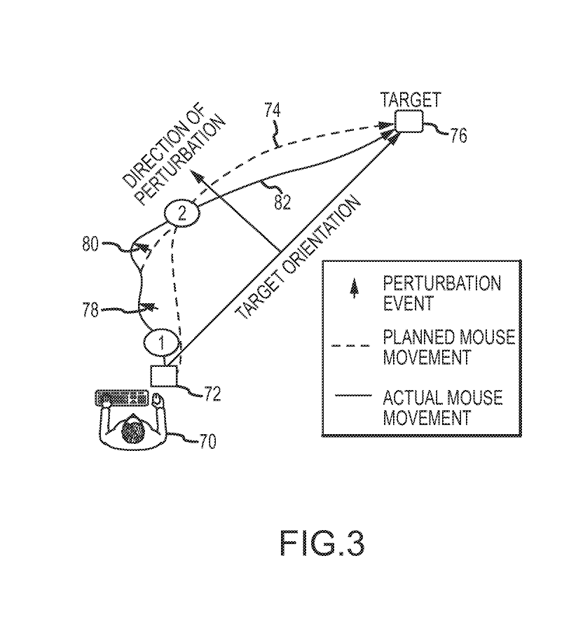

FIG. 3 illustrates the user mouse movement in response to a perturbation event. In this example, a user 70 would move a mouse 72 along a planned ballistic trajectory 74 to a target 76 on the display to “click” on some icon. At two locations, the perturbation engine determines that a condition for a certain state of a mouse event e.g. a minimum velocity has occurred and generates perturbations 78 and 80. In this example, the perturbation is to alter the position of the mouse icon on the display. The user responds to this ratification perturbation of his ballistic trajectory to move the mouse to the target so that the mouse actually follows a non-ballistic path 82. The engine records both unperturbed mouse movement and perturbed mouse movement paired to the time-stamped perturbations. This data can be used to build the biometric signature and/or to match the user to a biometric signature to authenticate and/or profile the user 70.

As shown in FIG. 4a, plots 90 and 92 show user response of 8 subjects from mouse movements in unperturbed (control) and perturbed conditions. The x and y axes in each plot represent the horizontal and vertical positions of the mouse, respectively. Perturbation conditions show increased dynamic range and richer spatiotemporal response.

As shown in FIG. 4b, plots 94, 96 and 98, 100 contain the distributions of 10 subjects with respect to multiple features (e.g. two or three features) extracted from mouse movements in unperturbed (control) and perturbed conditions, respectively. The x and y axes in each plot represent the first and second feature dimensions respectively. Ellipses represent mean-centered distributions of feature values for each subject. Perturbation conditions show increased separability, repeatability and robustness of the experimental subjects and increased information gain by extending feature dimensions as evidenced by the increase in separation with more features.

While several illustrative embodiments of the invention have been shown and described, numerous variations and alternate embodiments will occur to those skilled in the art. Such variations and alternate embodiments are contemplated, and can be made without departing from the spirit and scope of the invention as defined in the appended claims.

We claim:

1. A computer-implemented system for determining biometric signatures based on user mouse events, comprising:
a mouse monitor software module configured to monitor mouse events output by a mouse application program interface (API) coupled to a computer mouse, said mouse events including mouse position, scrolling and clicking events; and
a mouse perturbation engine software module configured to track the mouse events, said engine responsive to certain states of mouse events to generate a perturbation of a mouse event, said engine outputs the perturbation to the API to implement the perturbation of the mouse event, said engine pairing the perturbation with the mouse events responsive to said perturbation.

2. The system of claim 1, wherein one said certain state comprises a threshold velocity for changes in mouse position.

3. The system of claim 1, wherein said certain states are one or more of a threshold velocity, a threshold acceleration, a certain position, a certain angular movement, a certain scrolling event, a certain clicking event or a combination thereof.

4. The system of claim 1, wherein the perturbation includes one or more of altering the position of the mouse icon on a computer display, altering the velocity or acceleration sensitivity of the mouse to user mouse movement, altering the visibility of the mouse icon on a computer display, altering the mouse click response including altering a delay or suspending the mouse click, and altering the scrolling.

5. The system of claim 1, wherein the mouse perturbation engine generates different perturbations for different mouse events over a user session and outputs the paired perturbations and mouse events to the different perturbations.

6. The system of claim 1, wherein the mouse perturbation engine generates different perturbations for different mouse events over each user session and outputs the paired perturbations and mouse events to the different perturbations for each of a plurality of different users.

7. The system of claim 6, further comprising a mouse database that logs the paired perturbations and mouse events for each user to build a biometric signature for each user.

8. The system of claim 6, further comprising a mouse database that logs the pair perturbations and mouse events for groups of users based on a common trait to build a biometric signature for the common trait.

9. The system of claim 8, wherein the common trait is a user class selected from gender, age, ethnicity, a cognitive state, or combinations thereof.

10. The system of claim 1, further comprising:
a mouse database that logs the paired perturbation and mouse events to build a biometric signature for a user.

11. The system of claim 10, wherein the mouse database logs mouse events that are not paired with a perturbation to build the biometric signature.

12. The system of claim 10, further comprising:
a pre-processing and feature extraction module that extracts features from the paired perturbation and mouse events, said mouse database logging the features to build the biometric signature.

13. The system of claim 10, further comprising:
an authentication and profiling task module that compares the paired perturbations and mouse events to pre-stored biometric signatures in the database to output user authentication or user profile information.

14. The system of claim 13, wherein the pre-stored biometric signatures comprise user biometric signatures of individual users in the database, said task module outputting a user authentication of the current user of the computer system.

15. The system of claim 13, wherein the mouse perturbation engine tracks user mouse events responsive to perturbations to gather information to profile the user.

16. A computer-implemented system for determining biometric signatures based on user mouse events, comprising:
a mouse monitor software module configured to monitor mouse events output by a mouse application program interface (API) coupled to a computer mouse, said mouse events including mouse position, scrolling and clicking events;
a mouse perturbation engine software module configured to track the mouse events, said engine responsive to certain states of mouse events to generate a perturbation of a mouse event, said engine outputs the perturbation to the API to implement the perturbation of the mouse event, said engine pairing the perturbation with the mouse events responsive to said perturbation;
a mouse database configured to log the paired perturbation and mouse events to build a biometric signature; and
an authentication and profiling task module configured to compare the paired perturbation and mouse events to biometric signatures in the database to output user authentication or user profile information.

17. A computer-implemented method for determining biometric signatures based on user mouse events, comprising:
monitoring mouse events output by a mouse application program interface (API) coupled to a computer mouse, said mouse events including mouse position, scrolling and clicking events;
responsive to certain states of mouse events, generating a perturbation of a mouse event;
outputting the perturbation to the API to implement the perturbation to the mouse event; and
pairing the perturbation with the mouse events responsive to said perturbation.

18. The computer-implemented method of claim 17, further comprising:
logging the paired perturbation and mouse events to build a user biometric signature.

19. The computer-implemented method of claim 17, further comprising:
comparing the paired perturbations and mouse events to pre-stored biometric signatures in the database to output user authentication or user profile information.

20. The computer-implemented method of claim 17, further comprising:
logging the paired perturbation and mouse events based on a common trait to build a common trait biometric signature.
